(19) United States
(12) Patent Application Publication
(10) Pub. No.: US 2004/0204051 A1
(43) Pub. Date: Oct. 14, 2004

(54) Method and system for selecting provisioning information for mobile communication device from non-volatile memory

(76) Inventors: Clifton E. Scott, San Diego, CA (US); Scott Hackman, San Diego, CA (US)

Correspondence Address: Qualcomm Incorporated, Patents Department, 5775 Morehouse Drive, San Diego, CA, 92121-1714, US

(21) Appl. No.: 10/229,610

(22) Filed: Aug. 27, 2002

(51) Int. Cl. H04B 1/38

(52) U.S. Cl. 455/556.1; 455/551; 455/418

(57) ABSTRACT

A wireless communication device has logic that preferentially obtains provisioning information from a removable user identification module if one is provided, and otherwise obtains provisioning information resident in a permanently installed onboard non-volatile memory such as a flash memory device.

### FIELD OF THE INVENTION

The present invention relates generally to providing provisioning information to mobile communication devices such as wireless telephones.

### BACKGROUND OF THE INVENTION

Wireless communication devices require the knowledge of certain types of information related to themselves and to the wireless network on which they communicate. This information is generally referred to as “provisioning information”, because it is information related to the service that is provided to the device. For example, the provisioning information for a wireless telephone can include the telephones's Number Assignment Module (NAM), which includes device identifiers such as its Mobile Identification Number (MIN) and its International Mobile Station Identity (IMSI) (essentially, the “phone number” of the device) that are required for establishing a wireless connection. Additionally, the provisioning information can include a roaming list that contains information regarding the channels and systems the device should attempt to acquire to establish communication. The provisioning information might also list those systems that the device is not permitted to acquire. In any case, it will readily be appreciated that it is essential for the device to have access to its provisioning information.

In some wireless communication systems, the provisioning information for a wireless device is stored within the device on a permanently installed non-volatile memory, such as flash memory. In these systems, both the wireless communication device and the carrier service are procured from the service provider. In other systems, the provisioning information is not permanently installed in the wireless device but rather is stored on a removable memory medium referred to as a removable user identity module (R-UIM). In these systems, the wireless device itself may be procured from any retail outlet, with the actual service being obtained from a service provider who gives the R-UIM to the user for engagement of the R-UIM with the telephone.

In either case, as understood by the present invention the communication software of a wireless device currently must be programmed with the location of the provisioning information. In the case of a device intended to be used in a system having permanently installed provisioning information, the device must be programmed to look for the information in the permanent non-volatile memory of the device, whereas in the case of a device that must communicate in a R-UIM-based system, the device must be programmed to look for the information in the R-UIM. As further understood herein, this requires a maker of wireless communication devices to produce one software program for telephones intended to operate in one system and a second, different software program for telephones that are intended to operate in the other system, which is duplicative both in terms of software generation and in terms of software testing. Moreover, the present invention understands that it can be desirable that a single telephone be capable of working in either system. With these critical observations in mind, the present invention has been provided.

### SUMMARY OF THE INVENTION

A wireless communication device has a communication processor, a non-volatile memory such as a flash memory permanently accessible to the communication processor, and logic that can be executed by the processor for preferentially obtaining provisioning information from a removable user identification module (R-UIM) when a R-UIM is operationally engaged with the processor, and otherwise obtaining provisioning information from the flash memory.

In a preferred embodiment, the flash memory can be permanently supported in the same housing as the processor, whereas the R-UIM may be engaged and disengaged with the processor by hand. The provisioning information can include a device identification, service information necessary to place and receive calls, a Number Assignment Module (NAM) that in turn can include a Mobile Identification Number (MIN) and an International Mobile Station Identity (IMSI), and information regarding channels and systems the device should attempt to acquire to establish communication.

In another aspect, a wireless communication system includes a communication processor and a non-volatile memory that is non-removably associated with the processor. The memory stores provisioning information. A user identification module (UIM) is removably engageable with the processor, and the UIM also stores provisioning information.

In still another aspect, a method for establishing wireless communication includes selectively obtaining provisioning information for a wireless communication device from a removable memory or from a non-removable non-volatile memory that is associated with the device.

The details of the present invention, both as to its structure and operation, can best be understood in reference to the accompanying drawings, in which like reference numerals refer to like parts, and in which:

### BRIEF DESCRIPTION OF THE DRAWINGS/FIGURES

FIG. 1 is schematic diagram of a preferred non-limiting mobile (that is, wireless) communication device;

FIG. 2 is a block diagram of a preferred non-limiting implementation of the present device architecture; and

FIG. 3 is a flow chart illustrating the logic of the invention.

### DETAILED DESCRIPTION OF THE PREFERRED EMBODIMENT

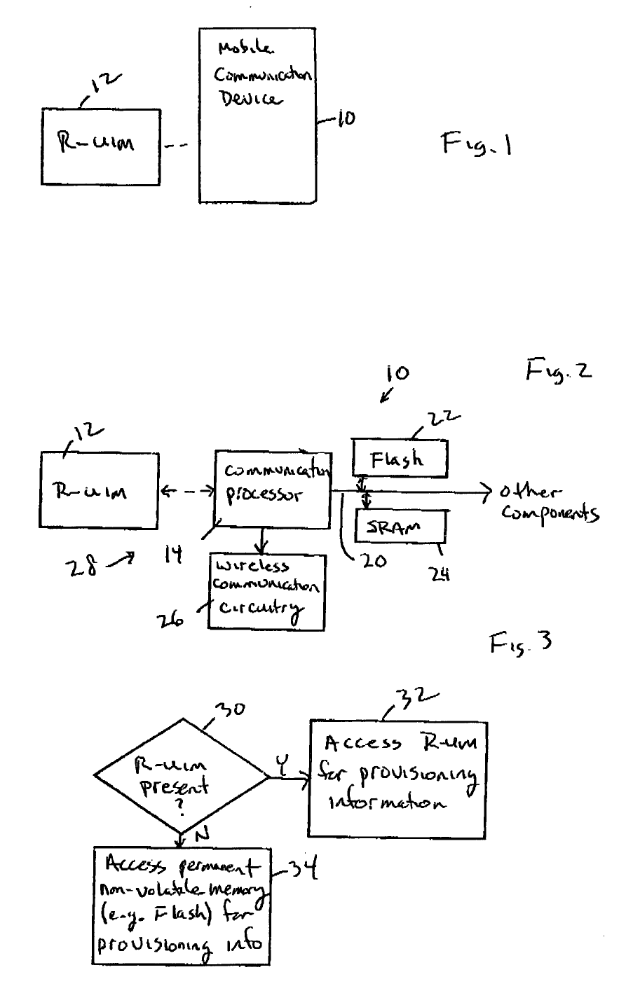

Referring initially to FIG. 1, a mobile communication device is shown, generally designated 10. In an exemplary non-limiting embodiment, the device 10 can be used to undertake wireless voice and/or data communication as well as personal computing application-based functions. In any case, the device 10 includes a preferably lightweight portable housing that holds the components discussed herein. As shown in FIG. 1, the device 10 can be removably engaged with a removable user identification module (R-UIM) 12, which contains, among other things, provisioning information. By “provisioning information” is meant device ID and service information necessary to place and receive calls, including, for example, the Number Assignment Module (NAM) of the device 10, which in turn can include device identifiers such as its Mobile Identification Number (MIN) and its International Mobile Station Identity (IMSI) (essentially, the “phone number” of the device) that are required for establishing a wireless connection. Additionally, the provisioning information can include a roaming list that contains information regarding the channels and systems the device should attempt to acquire to establish communication. The provisioning information might also list those systems that the device 10 is not permitted to acquire.

Now referring to FIG. 2, in a preferred non-limiting embodiment the device 10 includes a communication processor 14, preferably a type of processor referred to as a mobile system modem (MSM). The processor 14 can access a 16/32 bit bus 20 that can be implemented in a communication processor module. Using the bus 20 the communication processor 14 can access permanently installed non-volatile memory such as flash memory 22, as well as static random access memory (SRAM) 24. The processor 14 and memory 22 can be contained on the same chip or circuit board or other substrate within the device 10. Other components, such as software application processors for executing, e.g., the present assignee's “BREW” applications, can be accessed on the bus 20 if desired.

As also shown in FIG. 2, the communication processor 14 accesses wireless communication circuitry 26 to effect wireless communication in accordance with means known in the art. In other words, the communication processor 14, associated memories 22, and 24, and circuitry 30 establish a wireless voice and/or data communication portion, generally designated 28.

In one non-limiting embodiment, the communication portion 28, also referred to as a “mobile station (“MS”), is a mobile telephone-type device made by Kyocera, Samsung, or other manufacturer that uses Code Division Multiple Access (CDMA) principles and CDMA over-the-air (OTA) communication air interface protocols such as defined in but not limited to IS-95A, IS-95B, WCDMA, IS-2000, and others to communicate with wireless infrastructure, although the present invention applies to any wireless communication device.

For instance, the wireless communication systems to which the present invention can apply, in amplification to those noted above, include GSM, Personal Communications Service (PCS) and cellular systems, such as Advanced Mobile Phone System (AMPS) and the following digital systems: CDMA, Time Division Multiple Access (TDMA), and hybrid systems that use both TDMA and CDMA technologies. A CDMA cellular system is described in the Telecommunications Industry Association/Electronic Industries Association (TIA/EIA) Standard IS-95. Combined AMPS and CDMA systems are described in TIA/EIA Standard IS-95. Other communications systems are described in the International Mobile Telecommunications System 2000/Universal Mobile Telecommunications Systems (IMT-2000/UM), standards covering what are referred to as wideband CDMA (WCDMA), cdma2000 (such as cdma2000 1× or 3×air interface standards, for example) or TD-SCDMA.

In any case, provisioning information may be stored in permanent non-volatile memory in the device 10, such as the flash memory 22. Moreover, the processor 14 accesses the removable UIM 12, when provided, as shown in FIG. 2. Accordingly, provisioning information can also be stored on the R-UIM 12.

FIG. 3 shows the logic of the present invention that can be undertaken dynamically each time the device 10 is powered on, or each time a call is placed to or from the device, or upon some other condition. Commencing at decision diamond 30, it is determined whether the R-UIM is engaged with the device 10. This can be done by causing the processor 14 to attempt to communicate with the R-UIM 12, and if a response is received, presence of the R-UIM 12 is indicated. Otherwise, the processor 14 assumes that no R-UIM is present. Other methods for testing whether the R-UIM 12 is present may be used.

If the R-UIM 12 is present, the logic flows to block 32, wherein the processor 14 accesses the R-UIM 12 to obtain the provisioning information. Otherwise, the logic moves from decision diamond 30 to block 34 to obtain provisioning information from the permanently installed onboard non-volatile memory, such as the flash memory 22. It will be appreciated that the preferred device 10 preferentially obtains its provisioning information from the R-UIM 12.

In this way, only a single software build is required to support a device 10 that can be used in both R-UIM and non-R-UIM systems. This greatly reduces the testing required. The present invention also permits non-R-UIM systems to transition to R-UIM principles without requiring new software or new communication devices. The same device 10 can be used in both a non-R-UIM based system and then transported to and used in a R-UIM based system.

While the particular METHOD AND SYSTEM FOR SELECTING PROVISIONING INFORMATION FOR MOBILE COMMUNICATION DEVICE FROM NON-VOLATILE MEMORY as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. '112, sixth paragraph, unless the element is expressly recited using the phrase “means for” or, in the case of a method claim, the element is recited as a “step” instead of an “act”.

What is claimed is:

1. A wireless communication device, comprising:
at least one communication processor;
at least one non-volatile memory permanently accessible to the communication processor; and
logic executable by the processor for preferentially obtaining provisioning information from a removable user identification module (R-UIM) when a R-UIM is operationally engaged with the processor, and otherwise obtaining provisioning information from the non-volatile memory.

2. The device of claim 1, wherein the non-volatile memory is a flash memory.

3. The device of claim 1, wherein the non-volatile memory is permanently supported in the same housing as the processor.

4. The device of claim 1, wherein the R-UIM may be engaged and disengaged with the processor by hand.

5. The device of claim 1, wherein the provisioning information includes at least one device identification.

6. The device of claim 1, wherein the provisioning information includes at least one service information necessary to place and receive calls.

7. The device of claim 1, wherein the provisioning information includes at least one Number Assignment Module (NAM).

8. The device of claim 7, wherein the NAM includes at least one of: a Mobile Identification Number (MIN) and an International Mobile Station Identity (IMSI).

9. The device of claim 1, wherein the provisioning information is regarding channels and systems the device should attempt to acquire to establish communication.

10. A wireless communication system, comprising:
at least one communication processor;
at least one non-volatile memory non-removably associated with the processor, the memory storing provisioning information; and
at least one user identification module (R-UIM) removably engageable with the processor, the R-UIM storing provisioning information.

11. The system of claim 10, wherein the non-volatile memory is a flash memory.

12. The system of claim 10, wherein the processor and the non-volatile memory are supported on the same substrate as each other.

13. The system of claim 10, wherein the processor preferentially obtains provisioning information from the R-UIM.

14. The system of claim 10, wherein the provisioning information includes at least one of: a system identification, service information necessary to place and receive calls, a Number Assignment Module (NAM), a Mobile Identification Number (MIN), and an International Mobile Station Identity (IMSI).

15. The system of claim 10, wherein the provisioning information regards channels and systems the device should attempt to acquire to establish communication.

16. A method for establishing wireless communication, comprising:
dynamically obtaining provisioning information for a wireless communication device from a removable memory or from a non-removable non-volatile memory associated with the device.

17. The method of claim 16, wherein the device includes at least one processor, the removable memory is a removable user identification module (R-UIM), and the method includes preferentially obtaining the provisioning information from the R-UIM when the R-UIM is operationally engaged with the processor, and otherwise obtaining provisioning information from the non-volatile memory.

18. The method of claim 17, wherein the non-volatile memory is a flash memory.

19. The method of claim 17, wherein the processor and the non-volatile memory are supported on the same substrate as each other.

20. The method of claim 16, wherein the provisioning information includes at least one of: a system identification, service information necessary to place and receive calls, a Number Assignment Module (NAM), a Mobile Identification Number (MIN), and an International Mobile Station Identity (IMSI).

21. A system for establishing wireless communication, comprising:
means for dynamically obtaining provisioning information for a wireless communication device from a removable memory means or from a non-removable non-volatile memory means associated with the device.

22. The system of claim 21, wherein the device includes at least one processor, the removable memory means is a removable user identification module (R-UIM), and the system includes means for preferentially obtaining the provisioning information from the R-UIM when the R-UIM is operationally engaged with the processor, and otherwise obtaining provisioning information from the non-volatile memory.

23. The system of claim 22, wherein the non-volatile memory means is a flash memory.

24. The system of claim 22, wherein the processor and the non-volatile memory means are supported on the same substrate as each other.

25. The system of claim 21, wherein the provisioning information includes at least one of: a system identification, service information necessary to place and receive calls, a Number Assignment Module (NAM), a Mobile Identification Number (MIN), and an International Mobile Station Identity (IMSI).
